(19) United States
(12) Patent Application Publication
(10) Pub. No.: US 2019/0029284 A1
(43) Pub. Date: Jan. 31, 2019

(54) Apparatus and Method for Collecting Moisture and/or Trichomes from Tea Leaves or Other Produces

(71) Applicants: Hui Li, Fremont, CA (US); ChunGuang HU, QingDao (CN)

(72) Inventors: Hui Li, Fremont, CA (US); ChunGuang HU, QingDao (CN)

(21) Appl. No.: 15/664,278

(22) Filed: Jul. 31, 2017

(51) Int. Cl. A23F 3/06; B01D 5/00

(52) U.S. Cl. CPC A23F 3/06; B01D 5/006

(57) ABSTRACT

The present invention refers to an apparatus and method of collecting moisture and/or trichomes from fresh tea leaves or other fresh produces in general. It is a technique in tea manufacturing technology field, for assembling the ingredients rich of nutrient but ignored as waste, eliminating dust and enhancing the quality of finished product. A hood, a fluid container, and a pipe with proper length and shape work as a housing for trichome(s) and moisture to be either not filtered or filtered, chilled, condensed, and collected. An air pressure gradient is generated by an air suction/blowing device inscribed into a general tubular-shaped housing to inhale moisture and trichomes through the hood. If desired, one or more filters with suitable mesh size(s) can be installed at suitable location(s) along the housing for preventing clotting and collecting trichomes. A chilling device is installed in a suitable location in the housing for condensing moisture into fluid to be collected by a fluid container.

### BACKGROUND OF THE INVENTION

### 1. Field of the Invention

Present invention is about an apparatus and a method of collecting moisture evaporated from one or more produce(s) including but not limited to tea leaf and tea leaf trichome(s) for making a byproduct from making a typical dried goods or dried tea. It belongs to a technical field of processing produces, including fresh tea leaves, involving drying processes.

### 2. Description of the Related Art

Aqueous ingredients in fresh tea leaves occupy approximately 80% of weight of fresh tea leaves and approximately 75% of weight evaporates during processing. A significant amount of tea leaves has soft and fine trichomes. During a process, a significant amount of tea leaf trichomes leave tea leaf surfaces and fly up into air polluting a surrounding area and creating a hazard to workers' lungs if they are not collected. However, tea leaf trichomes are rich of tea polyphenols, amino acid, and caffeine. And moisture evaporated from fresh tea leaves is a valuable byproduct which can be developed as a new commodity. The absence of related equipment leads to several problems: waste of original and nutritious ingredients from fresh tea leaves, contamination of tea processing workshops and their surrounding areas, and lower quality of tea product due to the high humidity in a tea processing workshop. Similarly, in the procedure of processing other produce(s), the valuable water original from the produce(s) lost, and a device to collect the water is needed.

### BRIEF SUMMARY OF THE PRESENT INVENTION

To remove pre-processed tea leaf trichome(s) in tea leaves, reduce the humidity in the workshop and assemble the water original from produce(s), present invention provides workshops and chambers a system to purify the

For this purpose, present invention is: a produce moisture collector (PMC) that can be used as a tea leaf moisture and tea leaf trichome collector (TLMCC), as shown in FIG. 1, and a collection method. The system aspirates the steam-powder mixture generated during frying tea through a hood, filters the powder, condenses the steam and collects the water.

### BRIEF DESCRIPTION OF THE DRAWINGS

FIG. 1 illustrates an embodiment with mesh-size based filter(s) (MBF(s)) 101-103, air suction/blowing device(s) (AD(s)) 104 and a chilling device (CD) 105, which is placed upstream a fluid container 106 and downstream air suction/blowing device(s) (AD(s)) 104.

FIG. 2 illustrates the mesh sizes of mesh-size based filter(s) (MBF(s)) 101-103.

FIG. 3 illustrates an embodiment with mesh-size based filter(s) (MBF(s))101-103, air suction/blowing device(s) (AD(s)) 104 and the chilling device (CD) 105, which is placed inside the fluid container 106.

FIG. 4 illustrates an embodiment with the chilling device (CD) 105 placed inside the fluid container 106, a mesh-size based filter(s) (MBF(s)) 401 placed at an outlet port (OP) 111, and the air suction/blowing device(s) (AD(s)) 104 upstream the mesh-size based filter(s) (MBF(s)) 401.

FIG. 5 illustrates an embodiment with the chilling device (CD) 105 placed inside the fluid container 106, an air suction/blowing device(s) (AD(s)) 104 upstream it and a mesh-size based filter(s) (MBF(s)) 501 placed downstream the chilling device (CD) 105 and upstream a valve 108

FIG. 6 illustrates the shape and function of air suction/blowing device(s) (AD(s)) 104.

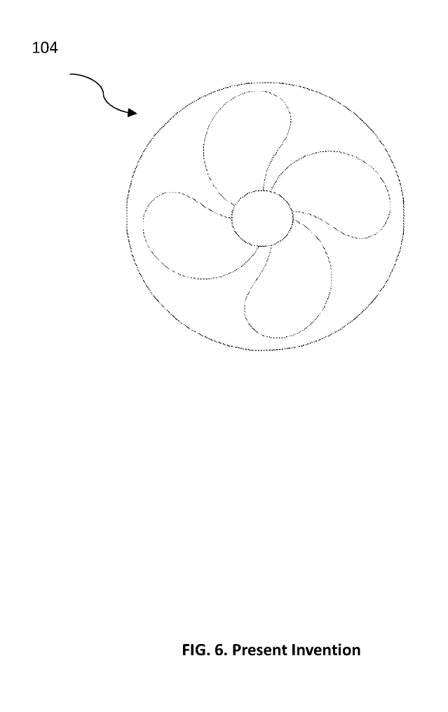

### DETAILED DESCRIPTION OF THE INVENTION

The following description with reference to exemplary and illustration drawings of the present invention will be further described in detail, but the present illustration is not intended to limit the embodiment of the present invention, any similar structure of the present invention and similar changes should be included in the scope of the present invention.

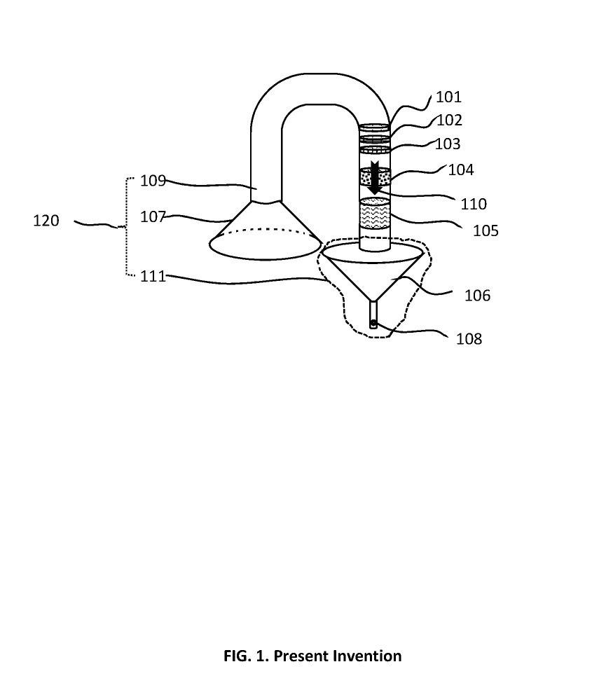

Below in conjunction with illustration with FIG. 1-5, the present invention will be described in detail as follows.

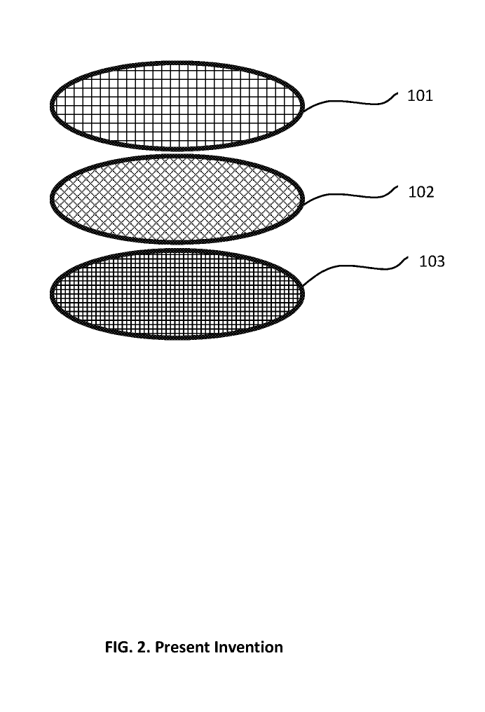

Present invention can be used as a tea leaf moisture and tea leaf trichome collector as shown in FIG. 1 and a collection method. The combination of a hood-shaped inlet port (IP) 107, a proper length of a pipe 109 and the funnel-shaped outlet port (OP) 111 is known as generally tubular-shaped housing (GTSH) 120, which provides a path for air flow. The IP 107 is assumed to be upstream and the OP 111 is assumed to be downstream, and the air flow follows along the direction of an air flow direction (AFD) 110 powered by an air suction/blowing device(s) (AD(s)) 104. Mesh-size based filter(s) (MBF(s)) 101-103 is placed upstream the air suction/blowing device(s) (AD(s)) 104, with an arrangement of coarser mesh upstream and finer mesh downstream, which is shown in FIG. 2, to prevent the air suction/blowing device(s) (AD(s)) 104 from clotting and to percolate the tea leaf trichome(s) out. The mesh-size based filter(s) (MBF(s)) 101-103 are replaceable, allowing the pre-processed tea leaf trichome(s) to be transferred to the next step. Located downstream the air suction/blowing device(s) (AD(s)), the chilling device (CD) 105 provides an area with lower temperature in the generally tubular-shaped housing (GTSH) 120 and allows the vapor to condense. The valve 108 is installed to control the bottling and canning.

Depending on needs, either no filter or one filter or multiple filters such as MBF(s) 101-103 can be installed at suitable locations along the generally tubular-shaped housing (GTSH) 120. Mesh-size based filter(s) (MBF(s)) can be placed at the outlet port (OP) 111 which is shown as 401, or before the valve 108, which is shown as 501, to prevent the system from clotting.

The chilling device (CD) 105 includes a refrigerant evaporator, associated with external parts including a refrigerant compressor, a condenser, and a receiver via coupling tubes for circulating the refrigerant. The refrigerant evaporator can be installed either downstream the air suction/blowing device(s) (AD(s)) 104 and upstream the outlet port (OP) 111 or inside the fluid container (FC) 106.

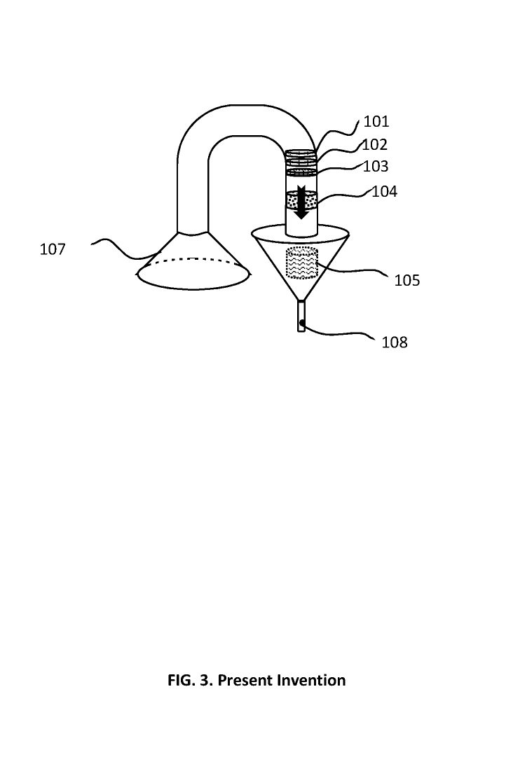

As shown in FIG. 3, the present invention disclosed an embodiment of a specific arrangement of the chilling device (CD) 105 which is placed inside the fluid container (FC) 106.

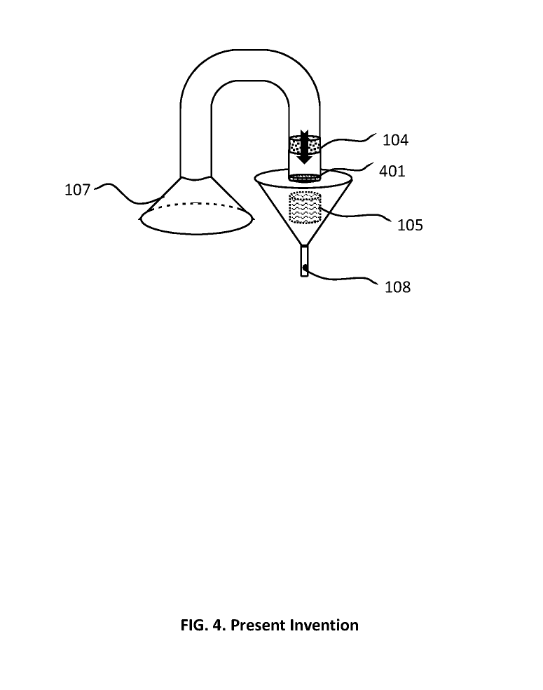

As shown in FIG. 4, the present invention disclosed an embodiment of a specific arrangement of the chilling device (CD) 105 which is placed inside the fluid container (FC) 106, and an alternative mesh-size based filter(s) (MBF(s)) 401 placed at the outlet port (OP) 111.

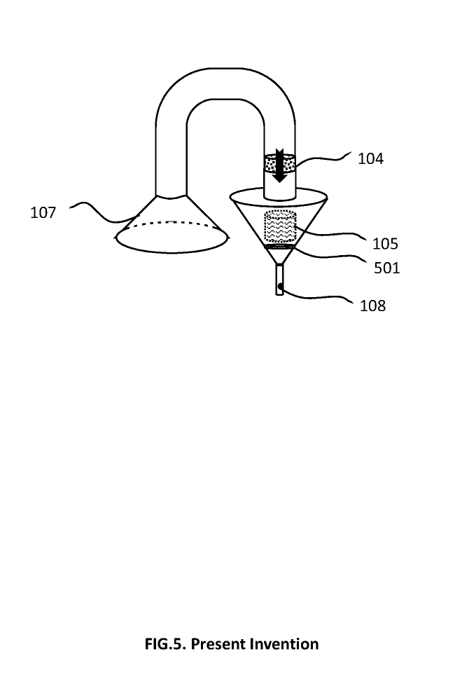

As shown in FIG. 5, the present invention disclosed an embodiment of a specific arrangement of the chilling device (CD) 105 which is placed inside the fluid container (FC) 106, and an alternative mesh-size based filter(s) (MBF(s)) 501 upstream the valve 108.

A method for collecting moisture either evaporated from one or more produce(s) or evaporated from tea leaves and tea leaf trichome flying up from surfaces of tea leaves when they are fried includes:

a. A generally tubular-shaped housing (GTSH) 120 with the inlet port (IP) 107 and the outlet port (OP) 111 with an air flow direction from the IP 107 to the outlet port (OP) 111, which direction is defined as the air flow direction (AFD) 110.

b. An air suction/blowing device(s) (AD(s)) 104 place embedded inside the pipe, making air flow.

c. A chilling device (CD) 105 embedded inside the GTSH 120.

The GTSH 120 described in the method has a hood enabling the vapor produced during the process of frying tea or drying produce(s) to be inhaled into to the GTSH 120. The OP 111 is connected to the funnel-shaped fluid container (FC) 106 to assemble the condensed water, and the valve 108 is installed at the narrow neck of the fluid container (FC) 106, acting as a switch. A group of replaceable mesh-size based filter(s) (MBF(s)) 101-103, if desired, are placed upstream the air suction/blowing device(s) (AD(s)) 104. The chilling device (CD) 105 is designed either upstream the fluid container (FC) 106 or inside the fluid container (FC) 106 to increase efficiency according to the situation. All parts are made of proper materials to satisfy engineering design.

1. A produce moisture collector (PMC) that can be used as a tea leaf moisture and trichome collector (TLMCC), for collecting moisture evaporated from one or more produce(s) including for collecting moisture evaporated from tea leaves and tea leaf trichomes flying up from surfaces of tea leaves during a process involving drying one or more fresh produce(s) including but not limited to fresh tea leaves of making one or more dried produce(s) including but not limited to a dried tea product, comprising:
a. a generally tubular-shaped housing (GTSH) having one or more inlet port(s) (IP(s)) and an outlet port (OP) assuming an air flow direction (AFD) from the IP(s) to the OP;
b. one or more air suction/blowing device(s) (AD(s)) located inside the GTSH for forming an air flow along the AFD; and
c. a chilling device (CD) located inside the GTSH.

2. The apparatus of claim 1 wherein each IP comprises a tubular coupler, with a suitable length, having an inlet and an outlet, wherein the inlet opening is preferred to be larger than the outlet opening and is for allowing moisture evaporated from one or more produce(s) including tea leaves and tea leaf trichome(s) to enter the GTSH during a process involving drying fresh produces or fresh tea leaf for making a dried produce or a dried tea product.

3. The apparatus of claim 1 wherein the OP comprises a fluid container (FC) having an inlet for receiving fluid accumulated inside the GTSH and having an outlet for outputting fluid inside the FC into bottles or cans for bottling or canning.

4. The apparatus of claim 3 wherein the outlet of the OP, if desired, comprises a valve for controlling fluid flow draining out from the FC.

5. The apparatus of claim 1 wherein the TLMCC further, if desired, comprises one or more coupled mesh-size based filter(s) (MBF(s)) installed at desired location(s) inside the GTSH along the AFD, having one at downstream with a finer mesh size than that of another one at upstream if needed.

6. The apparatus of claim 5 wherein the MBF(s) is/are preferred to be replaceable as needed.

7. The apparatus of claim 1 wherein each AD is capable of forming an air pressure gradient along the AFD.

8. The apparatus of claim 1 wherein the CD comprises a refrigerant evaporator, coupled with an external system comprising a refrigerant compressor, condenser, and receiver/storage via connecting tubes for transporting refrigerant, installed downstream from any/all AD(s), or, ideally inside the FC in the OP for allowing cold surfaces of the CD to have maximized contacts with accumulated moisture/fluid.

9. The apparatus of claim 1 wherein the CD comprises a structure with a suitable form and shape for achieving a highest efficiency including energy and material efficiencies.

10. The apparatus of claim 1 wherein all parts comprise suitable materials including stainless metal and non-metal materials.

11. A method for collecting moisture evaporated from one or more produce(s) including but not limited to tea leaves and tea leaf tea leaf trichomes flying up from surfaces of tea leaves during a process involving drying one or more produce(s) including but not limited to tea leaves for making dried produce products or a dried tea product, comprising:
a. forming, installing, and using a generally tubular-shaped housing (GTSH) having one or more inlet port(s) (IP(s)) and an outlet port (OP) assuming an air flow direction (AFD) from the IP(s) to the OP;
b. forming, installing, and using one or more air suction/blowing device(s) (AD(s)) into the GTSH at suitable locations for forming an air flow along the AFD by sucking in produce or tea leaf moisture and trichomes from the IP placed in a fresh produce or tea leaf processing area; and
c. forming, installing, and using a chilling device (CD) at a suitable location inside the GTSH.

12. The method of claim 11 wherein forming, installing, and using each IP of the GTSH comprises forming, installing, and using a tubular coupler, with a suitable length, having an inlet and an outlet, wherein the inlet opening is preferred to be larger than the outlet opening and is for allowing moisture evaporated from produce(s) or tea leaves during a fresh produce or tea leaf process of making a dried produce or tea product.

13. The method of claim 11 wherein forming, installing, and using the OP of the GTSH comprises forming, installing, and using a fluid container (FC) having an inlet for receiving fluid accumulated inside the GTSH and having an outlet for outputting fluid inside the FC into bottles or cans for bottling or canning.

14. The method of claim 13 wherein forming, installing, and using the outlet of the OP, if desired, comprises forming, installing, and using a valve for controlling fluid flow draining out from the FC.

15. The method of claim 11 wherein the method further, if desired, comprises forming, installing, and using one or more coupled mesh-size based filter(s) (MBF(s)) at suitable location(s) inside the GTSH along the AFD, having one at downstream with a finer mesh size than that of another one at upstream if needed.

16. The method of claim 15 wherein the MBF(s) is/are preferred to be replaceable as needed.

17. The method of claim 11 wherein forming, installing, and using each AD comprises forming, installing, and using its capability of forming an air pressure gradient along the AFD.

18. The method of claim 11 wherein forming, installing, and using the CD comprises forming, installing, and using a refrigerant evaporator, coupled with an external system comprising a refrigerant compressor, condenser, and receiver/storage via connecting tubes for transporting refrigerant, downstream from any/all AD(s), or, ideally inside the FC in the OP for allowing cold surfaces of the CD to have maximized contacts with accumulated moisture/fluid.

19. The method of claim 11 wherein forming, installing, and using the CD comprises forming, installing, and using a structure with a suitable shape for achieving a highest efficiency including energy and material efficiencies.

20. The method of claim 11 wherein forming, installing, and using all parts comprises forming, installing, and using suitable materials including stainless metal/alloy and non-metal/alloy materials.
